(19) United States
(12) Patent Application Publication
(10) Pub. No.: US 2008/0074687 A1
(43) Pub. Date: Mar. 27, 2008

(54) BROWSER INDEPENDENT COLOR MANAGEMENT

(76) Inventor: Stephen D. Upton, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/861,241

(22) Filed: Sep. 25, 2007

Related U.S. Application Data
(60) Provisional application No. 60/826,894, filed on Sep. 25, 2006.

(51) Int. Cl. H04N 1/60

(52) U.S. Cl. 358/1.9

(57) ABSTRACT

A method and system are disclosed wherein the method includes: receiving, by a computing device, color management information for utilization by a printing device, the color management information having been provided by a server that is remotely disposed from the computing device, monitoring, by the computing device, a driver of the printing device to detect rendering requests. In response to detecting a rendering request, facilitating the driver in using the color management information to affect at least one manifested color of content specified by the rendering request when the content is rendered by the printing device. The system includes a server having image data and color management information accessible by a remotely disposed computing device, and a computer controllable set of instructions for facilitating a printing device, coupled with the computing device, to render an image corresponding to the image in accordance with the color management information.

The present application is a continuation-in-part of and claims priority to U.S. Patent Application No. 60/826,894, filed Sep. 25, 2006, entitled “BROWSER INDEPENDENT COLOR MANAGEMENT,” the entire disclosure of which is hereby incorporated by reference in its entirety.

The invention relates generally to color management in image production and in particular to a method and apparatus for managing color independent of the color management resident in an Internet browser.

### BACKGROUND

Color graphics today, whether they are captured in a digital camera, displayed on a screen or printed on paper, are typically encoded using either Red Green and Blue color mixtures (RGB) or Cyan Magenta Yellow and Black inks (CMYK). Due to the different technologies and physical substances used in today's graphics devices, sending the same RGB or CMYK numbers to different devices results in different colors. A device-independent color measurement system has been created that allows numbers to be assigned to colors and the entire range of human perception is quantified by these numbers. The International Color Consortium (ICC) has created a translation system—the ICC color profile—which is used to convert between device-specific numbers, like CMYK, and device-independent color numbers, such as the L*a*b* color space. In a color managed system each device is subjected to a battery of measurements and subsequently an ICC profile is produced. This profile can be used in two ways: to translate colors requiring output from Lab to the device's numbers (such as CMYK) and to translate device numbers which are to be sent to the device (or came from the device) into color Lab numbers. Used in these manners, ICC profiles are used to get accurate, pleasing output from a graphics device as well as simulate the output device's behavior on a separate device—such as when a CMYK file is soft-proofed on a graphics display.

If color management is used in a printing path, it can change CMYK values via a printing path and then back to CMYK values. The result may be an incorrect color sampling. However, if the color management is turned off or otherwise disabled, a test file, for example a CMYK file, may have a gradient ramp of grey that's only in the black channel of that CMYK file. If the test file is printed and then viewed under a magnifier it would appear to contain only black ink.

However, if it's printed through a system that includes color management at some point, then it will have been typically converted to what is termed four-color black. It will look grey to the eye but, if magnified, it will have cyan, magenta, yellow and black dots in it.

The print, for which color management has occurred, is useless for profiling a CMYK device. The user will have to manipulate the color management path to determine how to shut off the color management, and then he or she will keep reprinting in an interactive fashion, until correct. If the test target is retrieved through a standard web browser, it is typically impossible to print it with no color management. In addition typical browsers can't even handle CMYK files.

Typically a user will download a “software kit” from a color management service's website with instructions on how to print a couple of target images. The target images are typically opened and printed from a graphics application such as Photoshop. However, many mistakes can be made, and often the color management is not turned off correctly. Typically about 30% of the CMYK targets received by a color management service for analysis have color management on. The color management service must then walk the user through the process until he or she prints it correctly. Even with instructions provided, a user may not always follow them. The procedure is complex, and leaves many opportunities for errors.

As an example, if a user was surfing around in Apple's browser called Safari, and found a JPEG and printed it, Safari would actually try to color manage it. In many cases, if a user is to print a target, which may be a page of patches, it is typically undesirable to allow color management to occur at the user's computer. The only way to guarantee the target prints correctly is for a trained and well-equipped color management service to print it using a controlled printer. In addition, various browsers behave in various ways.

### DRAWINGS

Embodiments of the present invention will be readily understood by the written description along with reference to the accompanying drawings and photographs. Embodiments of the invention are illustrated by way of example and not by way of limitation in the accompanying pictures and/or figures.

FIG. 1 illustrates a schematic view of a system in accordance with various embodiments of the present invention;

FIG. 2 illustrates a flow diagram of a method in accordance with various embodiments of the present invention; and

FIG. 3 illustrates a flow diagram of a method in accordance with various embodiments of the present invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The phrase “in one embodiment” is used repeatedly. The phrase generally does not refer to the same embodiment; however, it may. The terms “comprising,” “having,” and “including” are synonymous, unless the context dictates otherwise.

Various operations may be described as multiple discrete operations in turn, in a manner that may be helpful in understanding embodiments of the present invention; however, the order of description should not be construed to imply that these operations are order dependent.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB),” that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

For purposes of illustration, all or portions of software according to the invention may be referred to as a web browser application. A web site adapted to take part in aspects according to various embodiments of the invention may be referred to as a hosting web site.

Various embodiments may provide a color managed path for printing. Various embodiments of the invention may ensure that particular color conversions will take place. Various embodiments of the invention may ensure that no color conversions will take place. Various embodiments may provide the ability to print from a browser through a profiling package. Various embodiments may allow a user to initiate the printing of the CMYK file from within the browser application.

Various embodiments may enable a user to locate an image, for example a color calibration target, on the Internet, and launch a stand-alone application. The image may be located on a hosting website. Then the user may then print the image, and take some measurements with a color measurement device, such as a colorimeter or a spectrophotometer. Then the measurements may be uploaded to the hosting website, and may appear in the browser for the user.

The application may be registered as the handler of certain data types. For example the application may be registered with the operating system of a computing device as a preferred data handler for data type including but not limited to MIME (Multipurpose Internet Mail Extension), JavaScript, and the like.

Various embodiments may provide specified color management to the user's printing path. The user may then print the target for the purpose of calibrating the user's printer.

Various embodiments may enable a user to go to the hosting website, select the type of printer he or she would like to profile, and then print out a target specific to that printer. Embodiments may manage the printer path so the color is correctly managed for the target. Then a measuring device may be used to read the patches on the target to collect data and that may indicate how well calibrated the printer is. The results may help determine if the printer fits within predetermined parameters. The user may send the measurements to the color management service, who may then determine how well calibrated the printer is.

Various embodiments may be adapted to control the print path by, for example, bypassing the browser's printing capability and controlling the print path to either do correct color management or to disable color management. This may be required for printing a target correctly.

Various embodiments may provide an application that may be a stand-alone application. The application may be capable of web browsing, but may be restricted to specific parts of a predetermined website, for example, the hosting website. In various embodiments a user may not even realize that he or she is looking at web pages. Various embodiments may include, for example, an applet that may run resident on a user's machine, and may be resident only temporarily.

The applet may be a browser that may be adaptable to “surfing” the hosting website. In various embodiments the user may be prevented from, for example, inputting a URL. Various embodiments may control what the user sees.

The user may be able to download software and may run predetermined portions of the software, and may interact with menu items that may be part of the software. In various embodiments the software may open a web browser window that may interact with the user by, for example, asking questions. The software may allow the user to “sign up” on the hosting website and may do a variety of different things. In various embodiments predetermined “web type” pages may not be viewable in any other browser and the user may not even realize that he or she is using a nonconventional web browser.

In various embodiments the browser application may be adapted to include a user interface element, for example, a button that says, for example, “Print this target now,” The user may click on the interface element and the browser may recognize the click, then portions of the printing may be enabled through the web application and portions may be enabled through the hosting web site. However, in various embodiments the printing may appear to be done with only one program.

In various embodiments the user may locate a graphic in a website. The graphic may be displayed on a computer monitor as an RGB image but if the user asks to print it, the connection to the website may be modified to send a CMYK version of the graphic to the users printer. However, the color may be managed from the source, or from the hosting website, so that the graphic is printed to a predetermined specification.

Various embodiments may allow a user to purchase an image or photograph from a website with, for example, a credit card, and then print the image the way the artist or photographer intended it to be. This may save on shipping cost and delays.

A user may obtain software according to the invention by, for example, downloading if from the hosting website. Then, the software could be used to download and print the image from the Internet. In various embodiments, the image may not be color managed by the user's, but may instead be color managed by the hosting website.

The capability of the printer can be checked first by printing out a target, and then measuring and sending the results to the hosting website before printing the image or photograph according to various embodiments of the invention.

Various embodiments may provide the user the ability to browse the Internet viewing images that may be RGB representations of CMYK graphics files. Then, the user can decide to print an image by selecting an interface element such as a button labeled, for example, “Print Now.” The button may contain a certain link and that link would prompt the browser to launch software according to various embodiments of the invention. The software may then retrieve the correct image and print it with the proper, or preselected, color management criteria according to embodiments of the invention.

Various embodiments may provide a method of providing a controlled color managed print. The method may include:

Creating a user interface for example a link on a web page, for example, a web page on a hosting website. The link may include a specified file type with a specified file extension. For example the file type may be a MIME file type or javascript file type; and

Causing the web browser application to “hand off” the specified file from the (hosting web site) to the web browser application.

Various embodiments may further include:

Contacting the hosting website directly for additional information. The additional information may include specific printing instructions and also may also include an actual image file to be printed.

Various embodiments may further include:

Downloading relevant ICC profiles, conversion tables and/or palette files from the hosting website or some other public file system.

Various embodiments may further include:

Making various system calls which may be possible, or necessary, to disabling color management in the print path (or specifically enable it, if a color managed print is desired). In the case of a color managed print being the desired output, the web browser application, via certain criteria, for example user preference, may choose to perform the color management on the image itself rather than rely on the operating system or one or more print drivers.

In various embodiments, once the color management path is setup correctly, the application may make the necessary system calls to optionally perform the color transformation(s) and then print the file. If the file is in the CMYK color space (or any other non-RGB space), then a driver may be required to construct a Postscript or PDF-based print job.

According to various embodiments of the invention the method may include a user selecting the user interface, for example clicking link described above.

Various embodiments may include: registering the application with the operating system of the users computing device as the preferred data handler for the specified file type to ensure it receives the link from the browser. In various embodiments, all or parts of the functionality described could also be provided by software according to embodiments of the invention in, for example, the form of a browser plug-in.

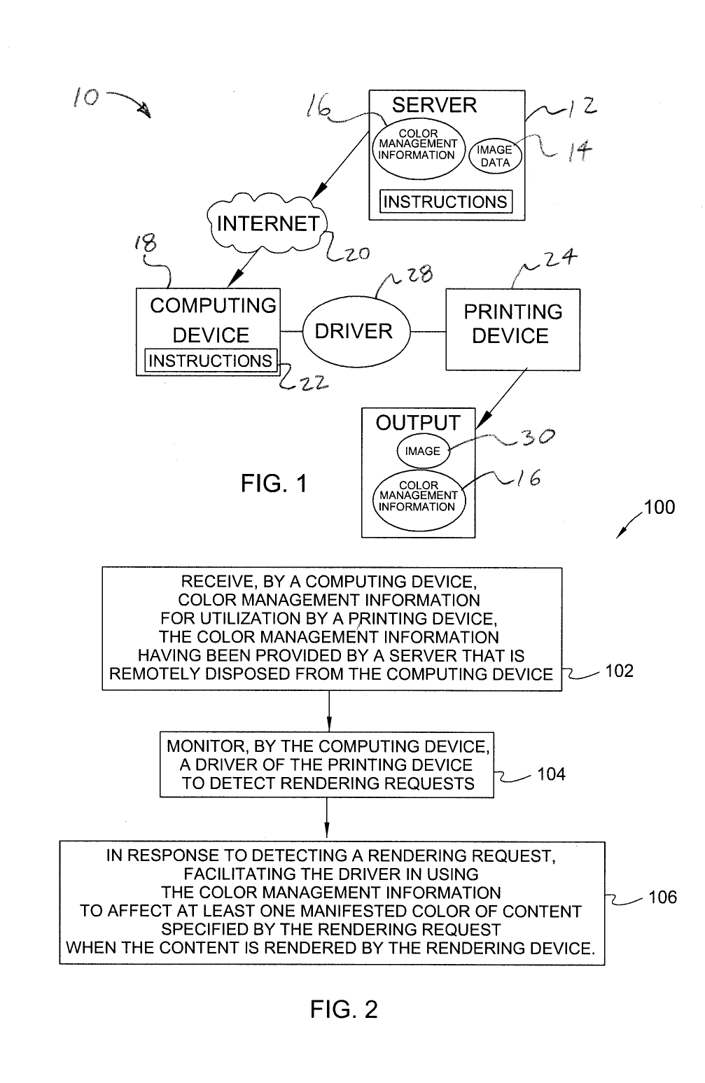

FIG. 1 is a schematic diagram illustrating various embodiments of the invention. A system 10 may include a server 12 having image data 14, and color management information 16. The server 12 may be accessible by a remotely disposed computing device 18. In some embodiments the access may be via the internet 20. A computer controllable set of instructions 22 and/or 22′ may be adapted for facilitating a printing device 24, which may be coupled with the computing device 18, to render an image 26 which may correspond with the image data 14 in accordance with the color management information 16.

In some embodiments the set of instructions 22 may be resident on the server 12. In other embodiments the set of instructions 22′ may be resident on the computing device 18. And in still other embodiments the set of instructions may be resident on both.

In some embodiments the color management information may instruct the computing device 18 to pass the image data to a printer driver 28 for printing with the printing device 24 without any color management of the image data 14 as image 30. And in other embodiments the color management information 16 may instruct the computing device to pass the image data 14 to the printing device 28 to print the image 30 with predetermined color management.

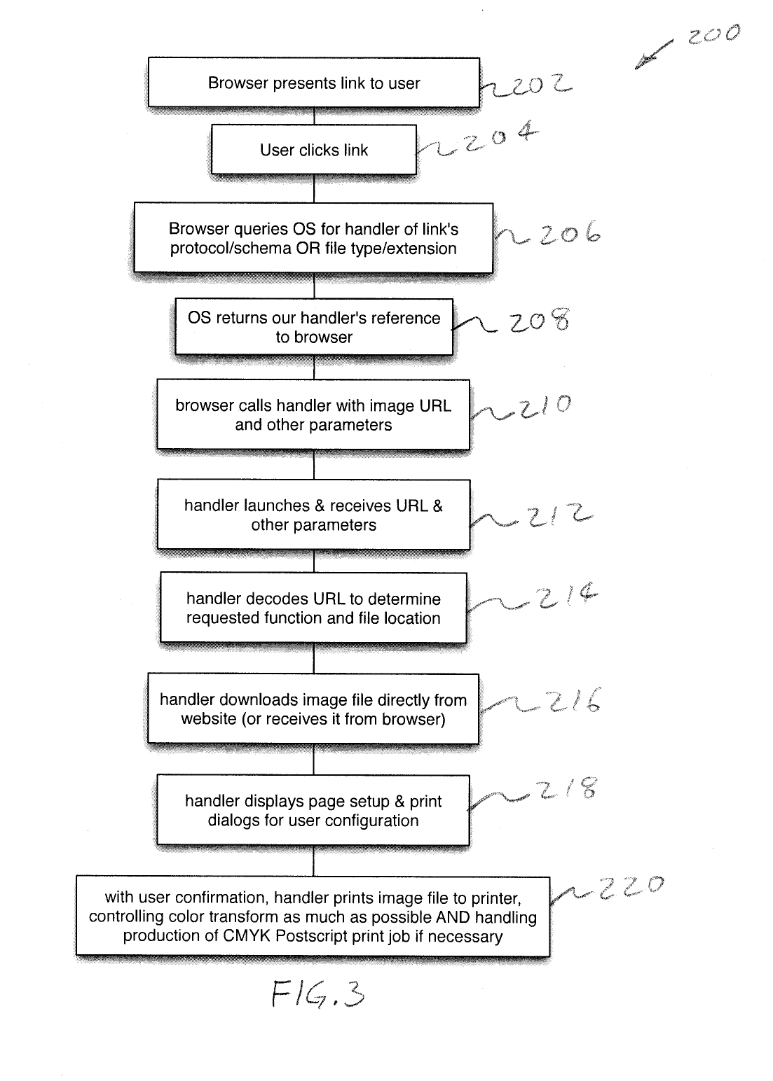

FIG. 2 is a flow diagram illustrating a method in accordance with various embodiments of the invention. A method 100 may include:

receiving, by a computing device, color management information for utilization by a printing device, the color management information having been provided by a server that is remotely disposed from the computing device 102;

monitoring, by the computing device, a driver of the printing device to detect rendering requests 104; and

in response to detecting a rendering request, facilitating the driver in using the color management information to affect at least one manifested color of content specified by the rendering request when the content is rendered by the printing device 106.

In various embodiments the receiving may be effected by a user clicking a web page link within an instantiation of a browser. Upon the clicking the web page link the browser queries an operating system of the computing device for a hander of the links protocol/schema or file type extension and launches a set of instructions. The set of instructions facilitates a graphical user interface to enable the user to confirm printing of the at least one manifested color of content.

FIG. 3 illustrates a method according to various embodiments. The method 200 may include:

presenting a link via a browser to a user, 202;

the user may then click the link, 204;

the browser may query an operation system (OS), for example the users computing device, for a hander of link's protocol/schema or file type/extension, 206;

the OS may then return a reference to a set of instructions in accordance with embodiments of the invention, 208;

the browser may call the application with a file URL as parameter, 210;

the set of instructions may launch and/or may receive URL parameter, 212;

set of instructions may decode the URL to determine a requested function and file location, 214;

the set of instructions may download image file directly from website, 216;

the set of instructions may display page setup & print dialogs for the user's configuration, 218;

with user confirmation, the set of instructions may print the image file to a printer, controlling color transform as much as possible and may handle production of a CMYK Postscript print job, if necessary, 220.

In addition to the discussion of various embodiments above, figures and additional discussion are presented herein to further describe certain aspects and various embodiments of the present invention. It is to be understood, however, that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

What is claimed is:

1. A method comprising:
receiving, by a computing device, color management information for utilization by a printing device, the color management information having been provided by a server that is remotely disposed from the computing device;
monitoring, by the computing device, a driver of the printing device to detect rendering requests; and
in response to detecting a rendering request, facilitating the driver in using the color management information to affect at least one manifested color of content specified by the rendering request when the content is rendered by the printing device.

2. The method of claim 1 wherein the receiving is effected by a user clicking a web page link within an instantiation of a browser.

3. The method of claim 2 wherein upon the clicking the web page link the browser queries an operating system of the computing device for a hander of the links protocol/schema or file type extension and launches a set of instructions.

4. The method of claim 3 wherein the set of instructions facilitates a graphical user interface to enable the user to confirm printing of the at least one manifested color of content.

5. A system comprising:
a server having image data and color management information accessible by a remotely disposed computing device;
a computer controllable set of instructions for facilitating a printing device, coupled with the computing device, to render an image corresponding to the image in accordance with the color management information.

6. The system of claim 5 wherein the set of instructions is resident on the server.

7. The system of claim 5 wherein the set of instructions is resident on the computing device.

8. The system of claim 5 wherein the image and the color management information are transferred from the server to the computing device via the internet.

9. The system of claim 5 wherein the color management information instructs the computing device to pass the image data to a printer driver for printing with the printing device with out any color management of the image.

10. The system of claim 5 wherein the color management information instructs the computing device to pass the image data to a printer driver for printing with the printing device with predetermined color management of the image.
